(19) United States
(12) Patent Application Publication
(10) Pub. No.: US 2009/0262418 A1
(43) Pub. Date: Oct. 22, 2009

(54) THREE-DIMENSIONAL DISPLAY DEVICE

(75) Inventors: Hae-Young YUN, Suwon-si, (KR); Kyoung-Ju SHIN, Hwasung-si, (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si, (KR)

(21) Appl. No.: 12/405,646

(22) Filed: Mar. 17, 2009

(30) Foreign Application Priority Data
Apr. 22, 2008 (KR) 10-2008-0037266

(51) Int. Cl. G02B 27/22; H04N 13/04

(52) U.S. Cl. 359/463; 348/59; 348/E13.075

(57) ABSTRACT

A display device which displays a three-dimensional image includes a display panel on which a plurality of pixels is formed and a lenticular sheet disposed above the display panel and including a plurality of cylindrical lenses formed on the lenticular sheet. Pixels of the of the plurality of pixels are arranged in a matrix comprising columns and rows, and a distance between centers of a pair of pixels in adjacent columns is equal to a distance between centers of a pair of pixels in adjacent rows. An axial direction of cylindrical lenses of the plurality of cylindrical lenses coincides with a diagonal direction of the pixels.

This application claims priority to Korean Patent Application No. 10-2008-0037266, filed on Apr. 22, 2008, and all the benefits accruing therefrom under 35 U.S.C. §119, the contents of which in its entirety are herein incorporated by reference.

### BACKGROUND OF THE INVENTION

1. Field of the Invention

The present invention relates to a display device, and more particularly, to a display device which displays a three-dimensional image not only when the display device is aligned horizontally, but also when the display device is rotated to be aligned vertically.

2. Description of the Related Art

Recently, demand has been increasing for flat panel display devices, such as plasma display panel (“PDP”) devices, plasma-addressed liquid crystal (“PALC”) display panel devices, liquid crystal display (“LCD”) devices and organic light-emitting diode (“OLED”) devices, for example, since conventional cathode ray tube (“CRT”) devices cannot meet demand for increasingly thin and large-scale display devices.

In addition, overall quality of images displayed by flat panel display devices has considerably improved. Furthermore, flat panel display devices capable of displaying both two-dimensional (“2D”) images, as well as three-dimensional (“3D”) images, have been developed. These so-called stereoscopic display devices display the 3D images by taking advantage of the fact that a viewer's left and right eyes see images from slightly different perspectives.

Methods of displaying 3D images on the stereoscopic display typically include using special glasses, holograms, a lenticular sheet or a barrier, for example.

More specifically, in a method of displaying 3D images using a lenticular sheet, for example, a 2D image of an object is divided into a first image for the right eye and a second image for the left eye. As a result, the image of the object is perceived by the viewer three-dimensionally, due to differences between the first image seen by the right eye and the second image seen the left eye.

An increasing number of display devices are being designed to be aligned in different orientations (e.g., such as in both horizontal and vertical directions). Thus, display quality of display devices which can be aligned in different directions has become an important area for improvement. However, methods of the prior art for displaying 3D images using a lenticular sheet are generally characterized by displaying 3D images along a direction perpendicular to an axial direction of the lenticular sheet. As a result, 3D display devices of the prior which use the lenticular sheet are not be able to display 3D images along a direction parallel to the axial direction of the lenticular sheet.

Therefore, it is necessary to develop a display device which displays 3D images regardless of an alignment of the display device, e.g., a display device which displays 3D images whether the display device is aligned horizontally or vertically.

### BRIEF SUMMARY OF THE INVENTION

Exemplary embodiments of the present invention provide a display device displays a three-dimensional (“3D”) image not only when the display device is aligned horizontally, but also when the display device is rotated to be aligned vertically.

According to an exemplary embodiment of the present invention, a display device includes a display panel on which a plurality of pixels is formed and a lenticular sheet disposed above the display panel and including a plurality of cylindrical lenses formed on the lenticular sheet. Pixels of the plurality of pixels are arranged in a matrix having columns and rows, and a distance between centers of a pair of pixels in adjacent columns is equal to a distance between centers of a pair of pixels in adjacent rows. An axial direction of cylindrical lenses of the plurality of cylindrical lenses coincides with a diagonal direction of the pixels.

According to an alternative exemplary embodiment of the invention, a display device includes a display panel on which a plurality of pixels is formed and a lenticular sheet disposed above the display panel and including a plurality of cylindrical lenses formed on the lenticular sheet. Pixels of the plurality of pixels are arranged in a matrix comprising columns and rows. An axial direction of cylindrical lenses of the plurality of cylindrical lenses forms an angle in a range of approximately 40° to approximately 50° with respect to one of a column direction and a row direction of the matrix. The pixels are arranged symmetrically with respect to the axial direction of the cylindrical lenses.

### BRIEF DESCRIPTION OF THE DRAWINGS

The above and other aspects, features and advantages of the present invention will become more readily apparent by describing in further detail exemplary embodiments thereof with reference to the accompanying drawings, in which:

FIG. 1 is an exploded perspective view of a display device according to an exemplary embodiment of the present invention;

FIG. 2 is a partial cross-sectional view taken along line II-II′ of FIG. 1;

FIG. 3 is a plan view of a cylindrical lens of a lenticular sheet and a plurality of pixels overlapped by the cylindrical lens of the display device according to the exemplary embodiment of the present invention shown in FIG. 1;

FIG. 4 is a plan view of a plurality of pixels viewed by a naked eye of a user through the lenticular sheet of the display device according to the exemplary embodiment of the present invention shown in FIG. 3;

FIG. 5 is a perspective view of the display device according to the exemplary embodiment of the present invention shown in FIG. 1 when the display device is horizontally aligned;

FIG. 6 is a perspective view of the display device according to the exemplary embodiment of the present invention shown in FIG. 1 when the display device is vertically aligned;

FIG. 7 is a plan view of a cylindrical lens of a lenticular sheet and a plurality of pixels overlapped by the cylindrical lens of a display device according to an alternative exemplary embodiment of the present invention;

FIG. 8 is a plan view of a plurality of pixels viewed by a naked eye of a user through the lenticular sheet of the display device according to the exemplary embodiment of the present invention shown in FIG. 7;

FIG. 9 is a perspective view of the display device according to the exemplary embodiment of the present invention shown in FIG. 7 when the display device is horizontally aligned;

FIG. 10 is a perspective view of the display device according to the exemplary embodiment of the present invention shown in FIG. 7 when the display device is vertically aligned;

FIG. 11 is an exploded perspective view of a display device according to another alternative exemplary embodiment of the present invention;

FIG. 12 is a plan view of a cylindrical lens arranged on a display panel of the display device according to the exemplary embodiment of the present invention shown in FIG. 11;

FIG. 13 is an exploded perspective view of a display device according to still another alternative exemplary embodiment of the present invention;

FIG. 14 is a plan view of a cylindrical lens arranged on a display panel of the display device according to the exemplary embodiment of the present invention shown in FIG. 13; and

FIG. 15 is an exploded perspective view of a display device according to yet another alternative exemplary embodiment of the present invention.

### DETAILED DESCRIPTION OF THE INVENTION

The invention will now be described more fully hereinafter with reference to the accompanying drawings, in which exemplary embodiments of the invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Furthermore, relative terms, such as “lower” or “bottom” and “upper” or “top” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the device in one of the figures were turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Exemplary embodiments of the present invention are described herein with reference to cross section illustrations which are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

Hereinafter, exemplary embodiments of the present invention will be described in further detail with reference to the accompanying drawings.

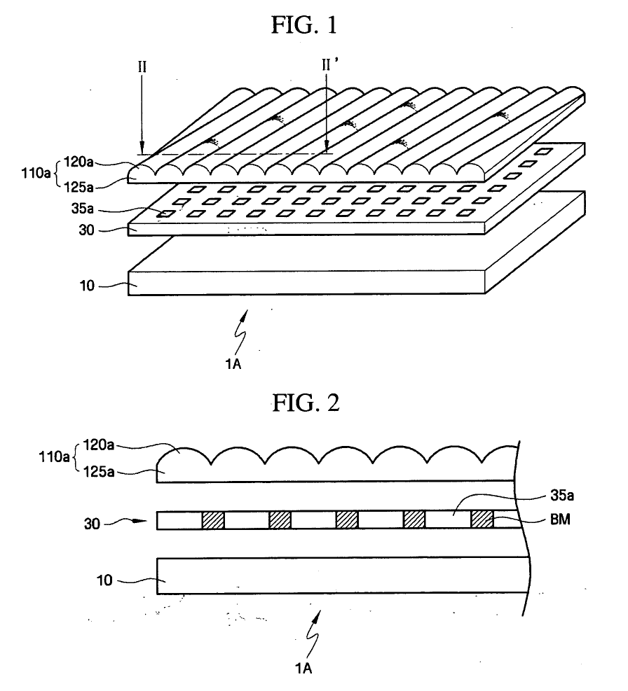

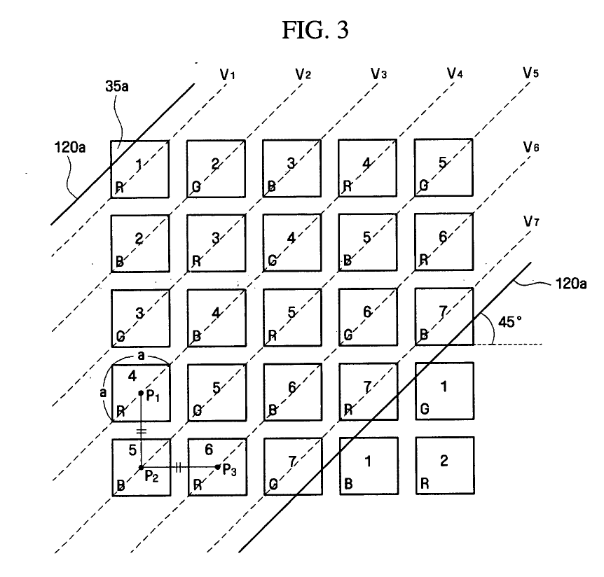

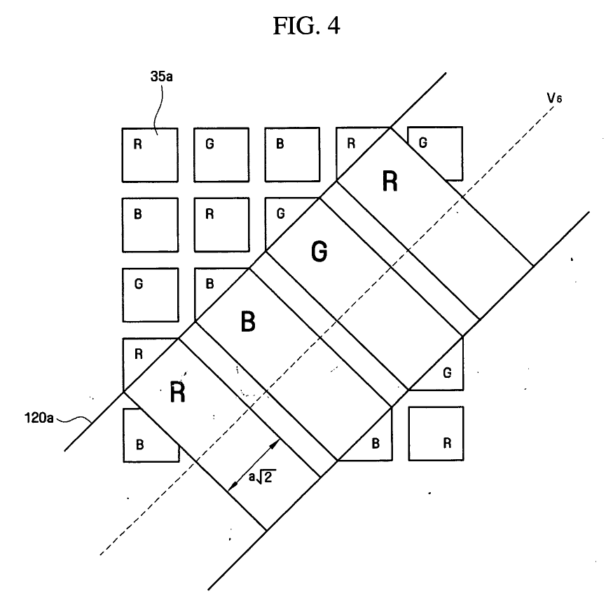

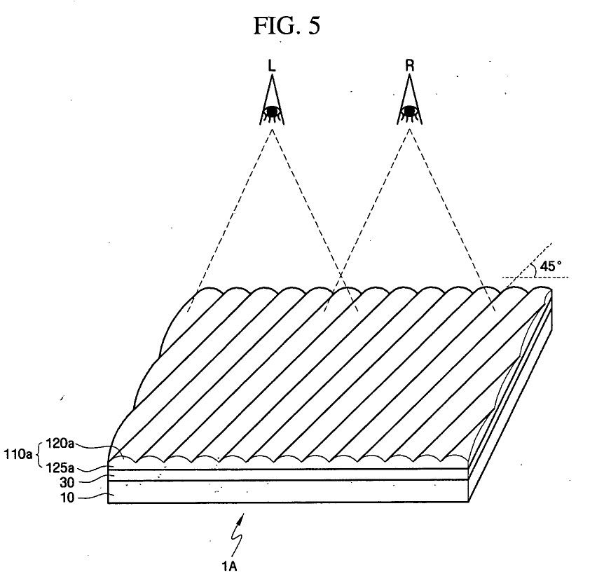

FIG. 1 is an exploded perspective view of a display device 1A according to an exemplary embodiment of the present invention, FIG. 2 is a partial cross-sectional view taken along line II-II′ of FIG. 1, FIG. 3 is a plan view of a cylindrical lens 120a of a lenticular sheet 110a and a plurality of pixels 35a overlapped by the cylindrical lens 120a of the display device 1A according to the exemplary embodiment of the present invention shown in FIG. 1, and FIG. 4 is a plan view of pixels 35a of the plurality of pixels 35a when viewed by a naked eye of a user through the lenticular sheet 110a of the display device 1A according to the exemplary embodiment of the present invention shown in FIG. 1.

Referring to FIGS. 1 and 2, the display device 1A includes the lenticular sheet 110a, a display panel 30 and a backlight assembly 10.

The lenticular sheet 110a enables a plurality of pixels 35a on the display panel 30 to be selectively viewable according to a viewpoint of the user. The lenticular sheet 110a includes a base 125a and a plurality of the cylindrical lenses 120a. The plurality of cylindrical lenses 120a is formed on the base 125a. The cylindrical lenses 120a are arranged at an angle from a horizontal direction or a vertical direction in which the pixels 35a are arranged.

The base 125a, maintains a shape of the cylindrical lenses 120a. The base 125a according to an exemplary embodiment may include a transparent material, for example, and may be formed as a single structure including the cylindrical lenses 120a.

As shown in FIG. 2, the cylindrical lenses 120a protrude from an upper, e.g., top, surface or, alternatively, a lower, e.g., bottom, surface of the base 125a and thereby extend over the base 125a along a predetermined direction. In an exemplary embodiment of the present invention, a cross-section of the cylindrical lenses 120a may be a semicircular cylinder or, alternatively, a semi elliptical cylinder, but alternative exemplary embodiments of the present invention are not limited thereto. Thus, the cylindrical lenses 120a may be multifocal lenses and/or may include a plurality of cut surfaces (not shown). The lenticular sheet 110a will be described in further detail below.

The display panel 30 displays an image and includes the pixels 35a. The pixels 35a are arranged on the display panel 30 in a matrix having columns and rows I which the pixels 35a are disposed. Put another way, the pixels 35a are arranged horizontally and vertically in the matrix according to a predetermined rule.

In the display device 1A, each of the pixels 35a may form a pixel of an image displayed on the display device 1A. Further, each pixel 35A may represent one of red (“R”), green (“G”) and blue (“B”) pixels of the image. In an exemplary embodiment of the present invention, the display panel 30 is a plasma display panel (“PDP”), or, alternatively, a plasma-addressed liquid crystal display panel (“PALC”), a liquid crystal display (“LCD”) panel or an organic light-emitting diode (“OLED”) panel, for example, but alternative exemplary embodiments are not limited to the abovementioned panels. Strictly for purposes of convenience in description herein, the display panel 30 will be described as an LCD panel.

As shown in FIG. 1, the backlight assembly 10 is disposed below the display panel 30. Thus, the display panel 30 provides light to the display panel 30, since the display panel 30 is a passive display panel (e.g., an LCD panel which requires an additional light source).

The display panel 30 display various images with light from the backlight assembly 10. Due to the lenticular sheet 110a, a given image displayed by the display panel 30 appears different to a user, based on a viewpoint, e.g., viewing angle, of the user.

The cylindrical lenses 120a and the pixels 35a will now be described in further detail with reference to FIGS. 2 and 3.

Referring to FIGS. 2 and 3, the lenticular sheet 110a is disposed above the display panel 30. As a result, the pixels 35a on the display panel 30 are overlapped by the cylindrical lenses 120a.

A viewpoint, defined as a position of a camera which captures an image to be displayed on the display device 1A, may be perpendicular to an axial direction of the cylindrical lenses 120a. In an exemplary embodiment of the present invention, the axial direction is a longitudinal axial direction of the cylindrical lenses 120a, as shown in FIG. 3. Further, a viewpoint is a relative position of each of the pixels 35a with respect to a direction substantially perpendicular to the axial direction of the cylindrical lenses 120a. Thus, the cylindrical lenses 120a may be arranged adjacent to each other, e.g., side by side, on an upper, e.g., top, surface of the base 125a. In addition, each of the cylindrical lenses 120a overlaps a number of the pixels 35a. Specifically, a number of the pixels 35a which are approximately perpendicular to the axis of each of the cylindrical lenses 120a displays an image which can be viewed from a given viewpoint. Thus, referring to a total number of pixels 35a overlapped by each of the cylindrical lenses 120a, a number of pixels 35a which are perpendicular to the axis of a corresponding cylindrical lens 120a is equal to a number of viewpoints generated by the corresponding cylindrical lens 120a.

The pixels 35a are arranged on the display panel 30 in a matrix. More specifically, black matrices BM, which do not display an image, are formed between adjacent pixels 35a to define rows and columns of the pixels 35a in the matrix. Further, the pixels 35a may be evenly spaced in both a horizontal direction and a vertical direction. In this case, the pixels 35a are formed as squares, each square having four sides of equal length “a”. As a result, a pattern of the arrangement of the pixels 35a is uniformly maintained when display panel 30 is rotated 90°.

As described above, the cylindrical lenses 120a are disposed over the pixels 35a. More than one pixel 35a may be overlapped by each of the cylindrical lenses 120a, as shown in FIG. 3. Referring to the total number of pixels 35a overlapped by each of the cylindrical lenses 120a, the number of pixels 35a which are perpendicular to an axis of a corresponding cylindrical lens 120a may be the same as the number of viewpoints generated by the corresponding cylindrical lens 120a.

To maintain even spacing between the pixels 35a in both the horizontal direction and the vertical direction, a distance between a central point P2 of a pixel 35a and a central point P1 of a pixel 35a vertically adjacent to the pixel 35a including the central point P2, e.g., a central point P1 of a pixel 35a in and adjacent row of the matrix, may be equal to a distance between the central point P2 and a central point P3 of a pixel 35a horizontally adjacent to the pixel 35a including the central point P2, e.g., a central point P3 of a pixel 35a in an adjacent column of the matrix.

In an exemplary embodiment of the present invention, an axial direction of the cylindrical lenses 120a forms an angle of approximately 45° with respect to the horizontal direction or the vertical direction, as shown in FIG. 3. Further, the pixels 35a may be arranged symmetrically with respect to the axial direction of the cylindrical lenses 120a. Thus, the pattern of the arrangement of the pixels 35a is uniformly maintained even when the display panel 30 is rotated by 90°.

In an exemplary embodiment of the present invention, viewpoints V₁ through V₇ are be generated by each of the cylindrical lenses 120a. Referring still to FIG. 3, broken lines have been drawn to illustrate the imaginary lines corresponding to axes of the viewpoints V₁ through V₇ arranged substantially in parallel with the axial direction of the cylindrical lenses 120a. In addition, each of the broken lines drawn to illustrate the viewpoints V₁ through V₇ corresponds to a number of pixels 35a that can be viewed from a corresponding viewpoint. Thus, referring to FIG. 3, numerals 1 through 7 in each pixel 35a indicate a number of pixels which can be viewed from a corresponding viewpoint. For example, pixels 35a having the reference numeral 3 can be viewed only from the viewpoint V₃.

In an exemplary embodiment of the present invention, a number of the pixels 35a which can be viewed from each of the viewpoints V₁ through V₇ are arranged in a direction substantially perpendicular to the axial direction of the cylindrical lenses 120a. Further, the pixels 35a may be arranged in a zigzag pattern in the direction substantially perpendicular to the axial direction of the cylindrical lenses 120a. Thus, a moire phenomenon, e.g., a moire pattern, is effectively prevented in the display device 1A according to an exemplary embodiment of the present invention.

Referring now to FIG. 4, the pixels 35a which can be viewed through the cylindrical lenses 120a extending in a direction perpendicular to the axial direction of the cylindrical lenses 120a along the viewpoint V₆ are shown. It will be noted, however, that different pixels 35a may be viewed from different viewpoints of the viewpoints V₁ through V₆. When the length and the width of pixels 35a are both equal to “a” (FIG. 3), as described above, the pixels 35a are viewed through the cylindrical lenses 120a as having a width of a\sqrt{2}, which is equal to the diagonal length of the pixels 35a, while having a same length as the width of the cylindrical lenses 120a. Put another way, the pixels 35a appear larger than they actually are when viewed through the cylindrical lenses 35a. As a result, a number of pixels 35a which are actually viewed may be less than a total number of the pixels 35a, and thus, a resolution of the display device 1A may appear to bean actual resolution of the display device 1A according to an exemplary embodiment of the present invention.

In an exemplary embodiment of the present invention, a distance between a pair of adjacent viewpoints may be equal to 1/\sqrt{5} a distance between the centers of a pair of horizontally or vertically adjacent pixels 35a, as described above in greater detail.

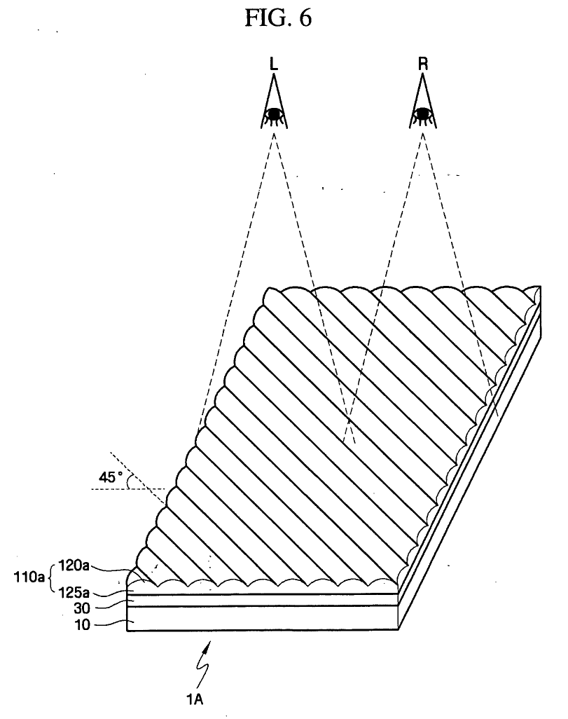

An observation angle for each alignment direction of the display device 1A will now be described in further detail with reference to FIGS. 4, 5 and 6. FIG. 5 is a perspective view of the display device 1A according to the exemplary embodiment of the present invention shown in FIG. 1 when the display device 1A is horizontally aligned, and FIG. 6 is a perspective view of the display device 1A according to the exemplary embodiment of the present invention shown in FIG. 1 when the display device 1A is vertically aligned.

Referring to FIGS. 4 and 5, the cylindrical lenses 120a form an angle of approximately 45° with a latitudinal direction, e.g., a direction corresponding to a peripheral side of the display panel 30 having a length less than a length of a longitudinal peripheral side of the display device 1A. Since the pixels 35a are formed as squares and are evenly spaced apart from one another in both the horizontal and vertical directions, the cylindrical lenses 120a are substantially parallel to a diagonal direction of the pixels 35a, as described in further detail above and shown in FIG. 3. Specifically, since the length of the pixels 35a is the same as the width of the pixels 35a, the resolution of the display device 1A is uniformly maintained when the display device 1A is viewed by the user in both the horizontal and vertical directions. In addition, the resolution of visible pixels 35a is lower than the actual resolution of the pixels 35a, as also described above. Thus, it is possible to uniformly maintain the resolution of the display device 1A in both the horizontal and vertical directions by forming the pixels 35a as squares and arranging the cylindrical lenses 120a substantially in parallel with a diagonal direction of the pixels 35a.

Referring to FIGS. 4 and 6, for example, even when the display device 1A is rotated by 90°, a relative arrangement of the pixels 35a and the cylindrical lenses 120a is maintained. Further, since the pixels 35a are formed as squares, a shape of the pixels 35a does not change when the display device 1A is rotated by 90°. Likewise, even when the cylindrical lenses 120a are rotated by 90° (together with the display device 1A), the cylindrical lenses 120a form an angle of about 135° or about 45° with the latitudinal direction of the display device 1A, and thus, relative arrangements of both the pixels 35a and the cylindrical lenses 120a is uniformly maintained. Therefore, a user, viewing a 3D image with a left eye L and a right eye R, sees the same 3D image regardless of whether the display device 1A is aligned vertically or horizontally, e.g., even when the display device 1A is rotated by 90°. Further, a quality of display is maintained even when the display device 1A is rotated by 90°.

Thus, as shown in FIGS. 5 and 6, a resolution of a 3D image displayed on the display device 1A according to an exemplary embodiment of the present invention remains the same whether the display device is oriented horizontally or vertically with respect to a user's viewing position.

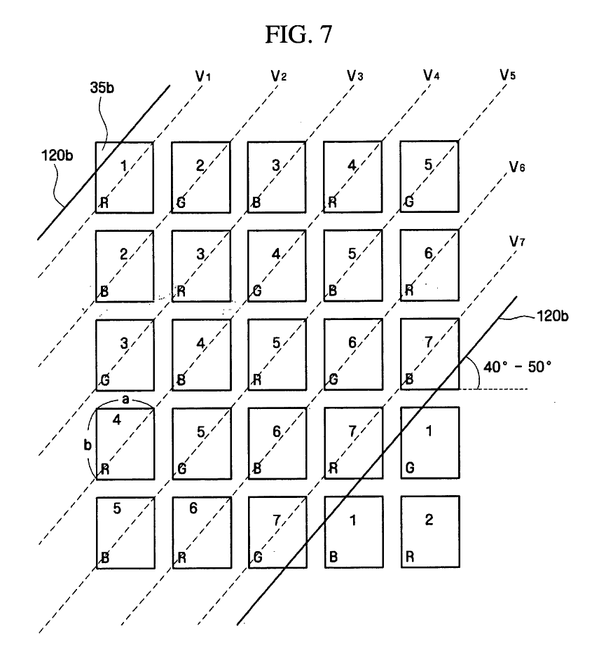

A display device according to an alternative embodiment of the present invention will now be described in further detail with reference to FIGS. 7 through 10.

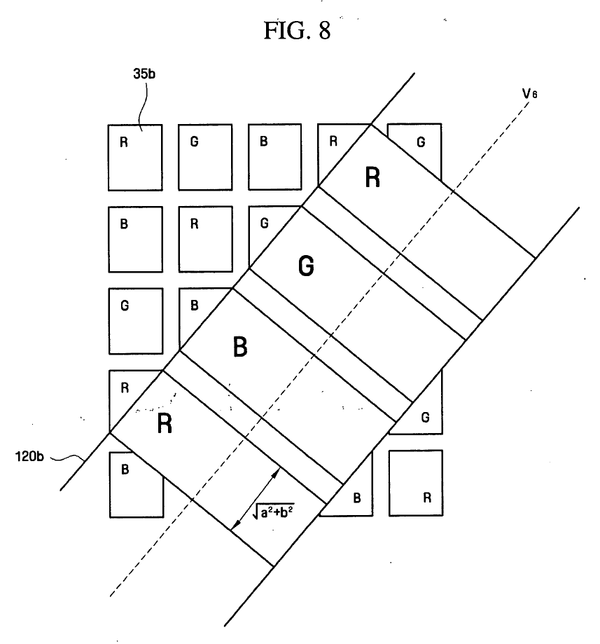

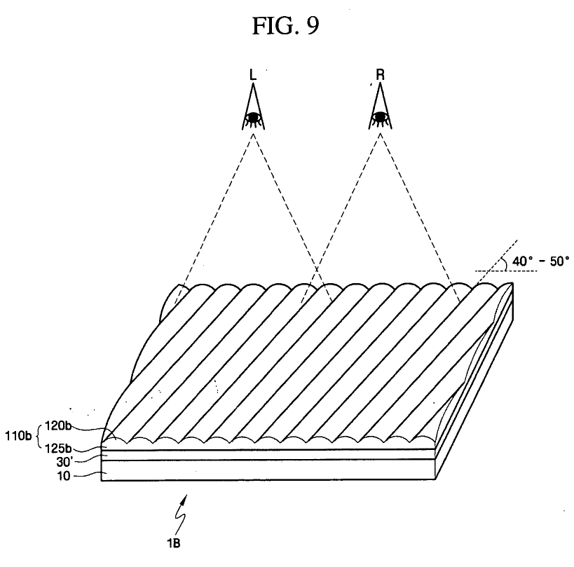

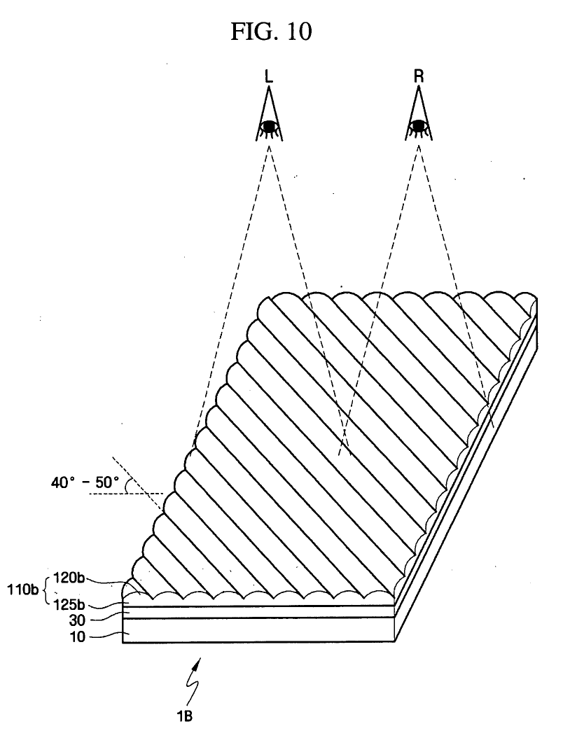

FIG. 7 is a plan view of a cylindrical lens 120b of a lenticular sheet 110b and a plurality of pixels 35b overlapped by the cylindrical lens 120b of a display device 1B according to an alternative exemplary embodiment of the present invention, FIG. 8 is a plan view of the pixels 35b when viewed by a left eye L and a right eye R of a user through the lenticular sheet 110b, FIG. 9 is a perspective view of the display device 1B when the display device 1B is horizontally aligned, and FIG. 10 is a perspective view of the display device 1B when the display device 1B is vertically aligned.

In the exemplary embodiment shown FIGS. 7 through 10, the display device 1B includes a plurality of pixels 35b. In the display device 1B, pixels 35b of the plurality of pixels 35b are rectangles (but not squares) and are arranged in a matrix having columns and rows. Further, an axial direction of a plurality of cylindrical lenses 120b forms an angle of approximately 40° to approximately 50° with respect to a horizontal or vertical direction in which the pixels 35b are arranged in the matrix.

The cylindrical lenses 120b and the pixels 35b will now be described in further detail with reference to FIG. 7.

The pixels 35b are arranged on a display panel 30′ in a matrix, and black matrices BM, which do not display an image, are formed between adjacent pixels 35b to form the matrix. The pixels 35b are evenly spaced one another in both the horizontal and the vertical directions. In an exemplary embodiment of the present invention, the pixels 35b are formed as rectangles, e.g., a longitudinal side of the pixels 35b is longer than a latitudinal side thereof.

More specifically, the pixels 35b may be arranged symmetrically with respect to each viewpoint V₁ through V₇. In this case, a ratio of a length of the latitudinal sides of each of the pixels 35b and a length of the longitudinal sides of each of the pixels 35b is uniformly maintained. For example, in an exemplary embodiment of the present invention wherein the length of the latitudinal sides of each of the pixels 35b is equal to “a” and the length of the longitudinal sides of each of the pixels 35b is equal to “b”, b is approximately 0.9 times to-approximately 1.1 times the length of a. Put another way, the pixels 35b are formed as rectangles having two opposite latitudinal sides and two opposite longitudinal sides. Lengths of each of the two opposite longitudinal sides are approximately 0.9 times to-approximately 1.1 times lengths of each of the two opposite latitudinal sides. As a result, a visibility in both the horizontal and vertical directions, and a resolution in both the horizontal and vertical directions, is uniformly maintained in the display device 1B according to an exemplary embodiment of the present invention.

Thus, since the pixels 35b are formed as rectangles having the two latitudinal sides and the two longitudinal sides whose length is a 0.9 times to approximately 1.1 times the length of the two latitudinal sides, a relative arrangement of the cylindrical lenses 120b and the pixels 35b is maintained, even when the display panel 30′ is rotated by 90°.

The cylindrical lenses 120b according to an exemplary embodiment of the present invention are disposed over the pixels 35b on a base 125b. As described in greater detail above with reference to FIG. 3, more than one pixel 35b may be overlapped by each of the cylindrical lenses 120b. Thus, with respect to a total number of pixels 35b overlapped by each of the cylindrical lenses 120b, a number of pixels 35b that are perpendicular to an axis of a corresponding cylindrical lens 120b is equal to a number of viewpoints generated by the corresponding cylindrical lens 120b.

To maintain even spacing between the pixels 35b in both the horizontal and the vertical directions, a distance between central points of a pair of horizontally adjacent pixels 35b or a distance between the central points of a pair of vertically adjacent pixels 35b is uniform across the display panel 30′.

Referring still to FIG. 7, the cylindrical lenses 120b according to an exemplary embodiment of the present invention form an angle of approximately 0° to approximately 5° with respect to a diagonal direction of the display panel 30′. Thus, the axial direction of the cylindrical lenses 120b forms an angle of approximately 40° to approximately 50° with respect to the horizontal or the vertical direction, as shown in FIG. 7. In this case, the pixels 35b are arranged asymmetrically with respect to the axial direction of the cylindrical lenses 120b. For example, when the display panel 30′ is rotated by 90° when the axial direction of the cylindrical lenses 120b forms an angle of approximately 40° with the horizontal direction, the axial direction of the cylindrical lenses 120b forms an angle of approximately 60° with the vertical direction. Further, the distance between a pair of adjacent viewpoints is 1/\sqrt{2} times a distance between the centers of the pair of horizontally or vertically adjacent pixels 35b, and a user thereby views a 3D image even when the display panel 30′ is rotated by 90°.

Further, the pixels 35b may be arranged in zigzag pattern along a direction substantially perpendicular to the axial direction of the cylindrical lenses 120b, thereby preventing an occurrence of a moire phenomenon, e.g., generation of a moire pattern, in the display device 1B according to an exemplary embodiment of the present invention.

Referring now to FIG. 8, the pixels 35b, when viewed through the cylindrical lenses 120b, have a width equal to \sqrt{a²+b²} and having a length equal to the width of the cylindrical lenses 120b.

An observation angle for each alignment direction of the display device 1B will now be described in further detail with reference to FIGS. 8, 9 and 10.

Referring to FIGS. 8 and 9, the cylindrical lenses 120b of the lenticular sheet 110b form an angle of approximately 40° to approximately 50° with the latitudinal direction of the display panel 30′. Since the pixels 35b are formed as rectangles and are evenly spaced apart from one another in both the horizontal and vertical directions, the cylindrical lenses 120b of the lenticular sheet 110b form an angle of approximately 0° to approximately 5° with a diagonal direction of the pixels 35b. In addition, a ratio of the length of the latitudinal sides of each of the pixels 35b to the length of the longitudinal sides of each of the pixels 35b is approximately 1:0.9 to about 1:1.1, and the distance between a pair of adjacent viewpoints is equal to 1/\sqrt{2} times the distance between the centers of the pair of the horizontally or vertically adjacent pixels 35b. As a result, a user views a 3D image on the display device 1 B according to an exemplary embodiment of the present invention.

Referring to FIGS. 8 and 10, when the display device 1B is rotated by 90°, the latitudinal sides and the longitudinal sides of each of the pixels 35b become longitudinal sides and latitudinal sides, respectively, and the angle between the axial direction of the cylindrical lenses 120b and the horizontal direction thereby becomes approximately 40° to approximately 50°. Thus, the ratio of the length of the latitudinal sides of each of the pixels 35b to the length of the longitudinal sides of each of the pixels 35b and the angle between the axial direction of the cylindrical lenses 120b and the horizontal direction is uniformly maintained when the display device 1B is rotated by 90°. Therefore, a user views the same 3D image even when the display device 1B is rotated by 90°. In addition, a quality of display is uniformly maintained when the display device 1B according to an exemplary embodiment of the present invention is rotated by 90°.

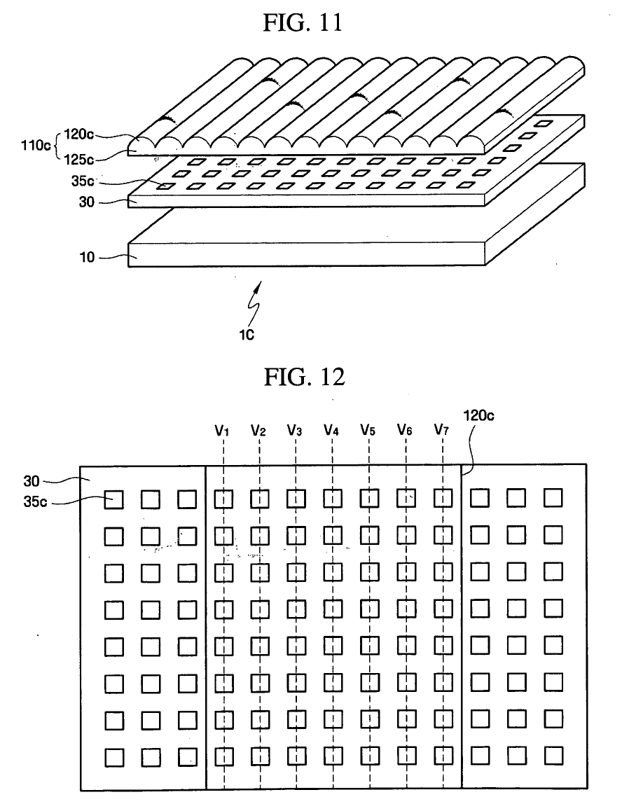

A display device according to another alternative exemplary embodiment of the present invention will now be described in further detail with reference to FIGS. 11 and 12. FIG. 11 is an exploded perspective view of a display device 1C according to another alternative exemplary embodiment of the present invention, and FIG. 12 is a plan view of a cylindrical lens 120c arranged on a display panel 30 of the display device 1C according to the exemplary embodiment of the present invention shown in FIG. 11. Specifically, in the display device 1C shown in FIG. 12, a cylindrical lens 120c is illustrated as being larger than it actually is to explain a relative arrangement of the cylindrical lens 120c and pixels 35c of a plurality of pixels 35c.

Referring to FIGS. 11 and 12, the display device 1C includes a display panel 30, on which the plurality of pixels 35c is arranged, and a lenticular sheet 110c, which has a plurality of cylindrical lenses 120c on a base 125c. The pixels 35c are arranged in a matrix having rows and columns. A distance between centers of a pair of adjacent pixels 35c is uniform across the whole display panel 30. An axial direction of the cylindrical lenses 120c is substantially perpendicular to longitudinal peripheral sides of the display panel 30.

When the display panel 30 is aligned so that the longitudinal peripheral sides of the display panel 30 are parallel to a substantially horizontal direction, the axial direction of the cylindrical lenses 120c is thereby substantially parallel to short, e.g., latitudinal, sides of the display panel 30. In this case, viewpoints V₁ through V₇ of a user are substantially parallel to the axial direction of the cylindrical lenses 120c. Thus, as the user moves in the horizontal direction relative to the display panel 30 (which is perpendicular to the axial direction of the cylindrical lenses 120c) a viewpoint of the user changes accordingly. As a result, the user views a 3D image on the display device 1C according to an exemplary embodiment of the present invention.

A ratio of a length of the latitudinal sides of each of the pixels 35c and a length of the longitudinal sides of each of the pixels 35c is uniformly maintained. For example, when the length of the latitudinal sides of each of the pixels 35c is equal to “a” and the length of the longitudinal sides of each of the pixels 35c is equal to “b”, b is approximately 0.9 times to approximately 1.1 times a. Thus, the length of the latitudinal sides of each of the pixels 35c is almost the same as the length of the longitudinal sides of each of the pixels 35c. As a result, display device 1C according to an exemplary embodiment of the present invention includes the display panel 30 whose long sides are aligned in the horizontal direction and whose long sides are aligned in the vertical direction when the display panel 30 is rotated 90°.

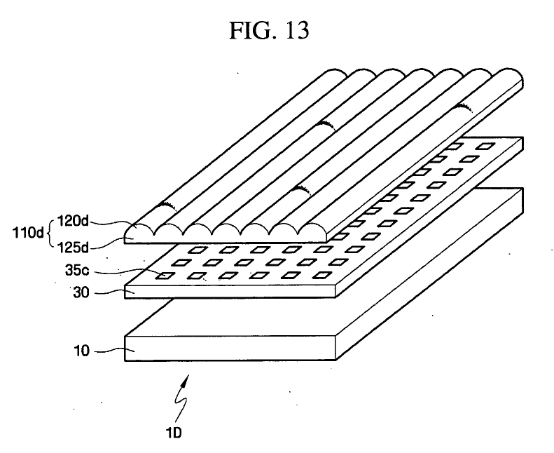

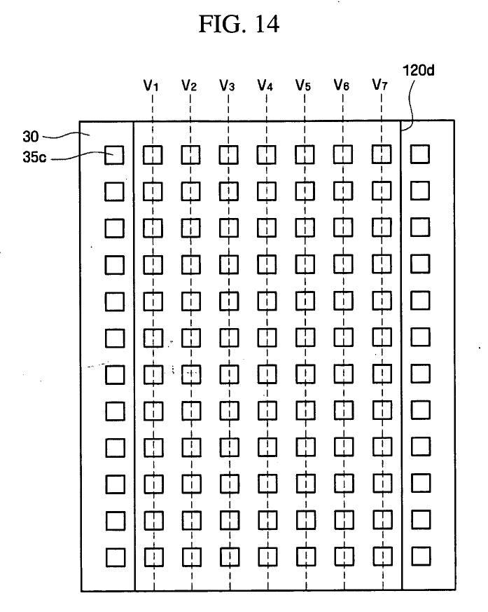

A display device according to still another alternative exemplary embodiment of the present invention will now be described in further detail with reference to FIGS. 13 and 14. FIG. 13 is an exploded perspective view of a display device 1D according to still another alternative exemplary embodiment of the present invention, and FIG. 14 is a plan view of a cylindrical lens 120d arranged on a display panel 30 of the display device 1D according to the exemplary embodiment of the present invention shown in FIG. 13. Specifically, in FIG. 14, a cylindrical lens 120d is illustrated as being larger than it actually is, to illustrate a relative arrangement of the cylindrical lens 120d and pixels 35c of a plurality of pixels 35c.

Referring to FIGS. 13 and 14, the display device 1D includes a display panel 30, which has longitudinal sides aligned in a substantially vertical direction and on which a plurality of pixels 35c are arranged in a matrix having rows and columns, and a lenticular sheet 110d, which has a plurality of cylindrical lenses 120d disposed on a base 125d. An axial direction of the cylindrical lenses 120d is substantially parallel to a direction of the longitudinal sides of the display panel 30.

A ratio of the length of latitudinal sides of each of the pixels 35c and the length of the longitudinal sides of each of the pixels 35c is uniformly maintained in an exemplary embodiment of the present invention. In this case, even when the display panel 30 is rotated by 90°, a pattern of the pixels 35c is uniformly maintained. Thus, the display device 1D according to an exemplary embodiment of the present invention display a 3D image which is longer in a vertical direction than in a horizontal direction, by rotating the display panel 30 illustrated in FIG. 12 by 90° and arranging the cylindrical lenses 120d so that the axial direction of the cylindrical lenses 120d is substantially parallel to the longitudinal sides of the display panel 30.

Therefore, the display device 1D according to an exemplary embodiment of the present invention includes the display panel 30 having longitudinal sides aligned in the horizontal direction, and, alternatively, the display device includes the display panel 30 having longitudinal sides aligned in the vertical direction, based on by selectively coupling the lenticular sheet 110c or 110d to the display panel 30 during manufacturing the display device 1D.

As a result, an alignment direction of the display device 1D is easily changed by selectively coupling the lenticular sheet 110c or 110d to the display panel 30. Therefore, two different types of display devices can be efficiently and easily manufactured.

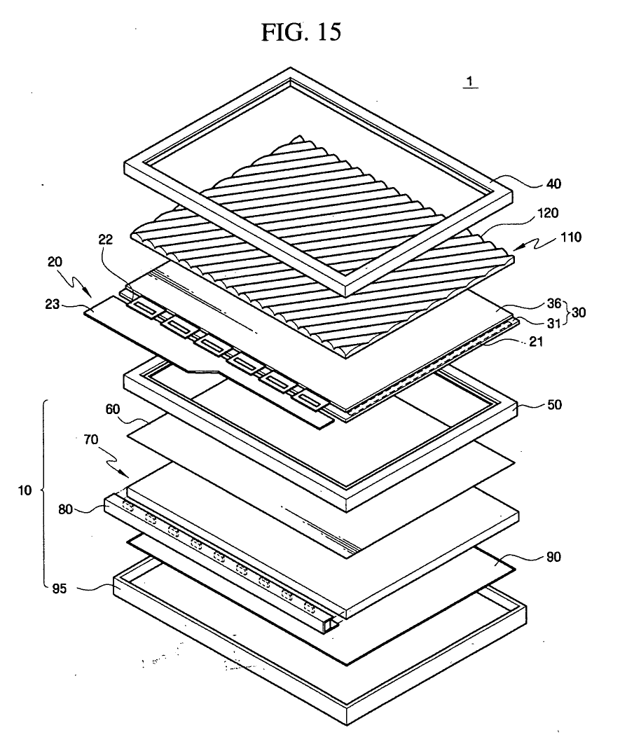

A display device according to still another alternative exemplary embodiment of the present invention will now be described in further detail with reference to FIG. 15.

FIG. 15 is an exploded perspective view of a display device 1 according to still another alternative exemplary embodiment of the present invention. Referring to FIG. 15, the display device 1 includes a lower display panel 31, on which a thin-film transistor (TFT) array (not shown) is formed, an upper display panel 36 which faces the lower display panel 31, and a liquid crystal layer (not shown) interposed between the lower display panel 31 and the upper display panel 36.

The display device 1 also includes a lenticular sheet 110, a display panel assembly 20, a backlight assembly 10, a middle frame 50, an upper container 40 and a lower container 95.

The display panel assembly 20 includes a display panel 30, which includes the lower display panel 31 and the upper display panel 36, the liquid crystal layer, a gate driving integrated circuit (“IC”) 21, a plurality of data tape carrier packages (“TCPs”) 22, and a printed circuit board (“PCB”) 23.

The display panel 30 includes the lower display panel 31, on which a plurality of gate lines (not shown), a plurality of data lines (not shown), the TFT array and a plurality of pixel electrodes (not shown) are formed, and the upper display panel 36, on which a plurality of color filters (not shown), black matrices (not shown) and a common electrode (not shown) are formed. The upper display panel 36 is disposed opposite to, e.g., faces, the lower display panel 31, as shown in FIG. 15.

In an alternative exemplary embodiment of the present invention, the color filters and the common electrode may be formed on the lower display panel 31, instead of being formed on the upper display panel 36. The lenticular sheet 110, which includes a plurality of cylindrical lenses 120, is disposed on the display panel 30.

The gate driving IC 21 may be formed on the lower display panel 31, and may be connected to the gate lines on the lower display panel 31. The data TCPs 22 may be connected to the data lines on the lower display panel 31. The data TCPs 22 may include, for example, tape automated bonding (“TAB”) tapes which connect a semiconductor chip (not shown) to wiring patterns (not shown) on a base film (not shown). It will be noted that alternative exemplary embodiments of the present invention are not limited to TCPs; instead, chip-on-films (“COFs”) may be used as chip film packages, although exemplary embodiments of the present invention are not limited thereto.

Driving elements (not shown) which apply a gate driving signal to the gate driving IC 21 and which apply a data driving signal to the data TCPs 22 may be mounted on the PCB 23.

The backlight assembly 10 includes a plurality of optical sheets 60, a light guide plate 70, one or more light sources 80 and a reflective sheet 90.

The light guide plate 70 guides light provided by the light sources 80 to the display panel assembly 20. The light guide plate 70 may be formed of a transparent material such as a plastic material (e.g., acrylic plastic), to enable light generated by the light sources 80 to proceed toward the display panel 30 disposed above the light guide plate 70.

The light sources 80 provide light to the display panel 30. Thus, at least one light source 80 is included in the backlight assembly 10. Point light sources, such as light-emitting diodes (“LEDs”), may be used as the light sources 80, but alternative exemplary embodiments of the present invention are not limited thereto.

The reflective sheet 90 is disposed on a lower, e.g., bottom, surface of the light guide plate 70, as shown in FIG. 15. The reflective sheet 90 reflects light emitted from the bottom of the light guide plate 70 back toward the light guide plate 70 or, alternatively, to the display panel 30 through the light guide plate 70, thereby minimizing a loss of the light emitted from the light sources 80 while also improving a uniformity of the light provided to the display panel 30 through the light guide plate 70.

Optical sheets 60 of the plurality of optical sheets 60 are disposed on an upper, e.g., top, surface of the light guide plate 70. The optical sheets 60 diffuse and collect light incident thereupon from the light guide plate 70. The optical sheets 60 according to an exemplary embodiment of the present invention include at least one of a diffusion sheet, a prism sheet and a protective sheet. The diffusion sheet diffuses light incident thereupon from the light guide plate 70, thereby preventing the light from being concentrated in specific regions. The prism sheet may include an array having a plurality of prisms, and may collect light diffused by the diffusion sheet and emit the light in a direction substantially perpendicular to the display panel 30. Since most of the light transmitted through the prism sheet travels straight, a distribution of luminance of the protective sheet thereby becomes uniform. Thus, the protective sheet uniformly distributes light by diffusing the light.

The reflective sheet 90, the light sources 80, the light guide plate 70, and the optical sheets 60 are disposed in the lower container 95. The lower container 95 according to an exemplary embodiment of the present invention may be formed of a metal material, for example, to provide sufficient rigidity and to serve as an electrical ground.

The middle frame 50 may be formed as a rectangular frame having four sidewalls forming the rectangular frame. The middle frame 50 may be fixed to the lower container 95.

The display panel 30 is disposed on the optical sheets 60, and more particularly, on the protective sheet, which is disposed in the middle frame 50. The middle frame 50 according to an exemplary embodiment may be formed as a plastic mold frame, for example, to prevent breakdown of various elements contained in the middle frame 50.

The upper container 40 is coupled to the lower container 95 to cover the top surface of the display panel 30 which is disposed in the middle frame 50. The upper container 40 has an aperture, e.g., a window, which is formed through the top surface of the upper container 40 to expose the display panel 30 therethrough. The upper container 40, like the lower container 95, may be formed of a metal material, for example, to provide sufficient rigidity and to serve as an electrical ground. In an exemplary embodiment of the present invention, the upper container 40 may be hook-coupled to the lower container 95.

The PCB 23 may be bent along an outer lateral surface of the middle frame 50, and may be settled on a lateral surface and/or the bottom surface of the lower container 95.

According to exemplary embodiments of the present invention as described herein, display device provides advantages which include, but are not limited to, displaying a three-dimensional image not only when the display device is aligned horizontally, but also when the display device rotated to be aligned vertically.

The present invention should not be construed as being limited to the exemplary embodiments set forth herein. Rather, these exemplary embodiments are provided so that this disclosure will be thorough and complete and will fully convey the concept of the present invention to those skilled in the art.

While the present invention has been particularly shown and described with reference to exemplary embodiments thereof, it will be understood by those of ordinary skill in the art that various changes in form and details may be made therein without departing from the spirit or scope of the present invention as defined by the following claims.

What is claimed is:

1. A display device comprising:
a display panel on which a plurality of pixels is formed; and
a lenticular sheet disposed above the display panel and comprising a plurality of cylindrical lenses formed on the lenticular sheet, wherein
pixels of the plurality of pixels are arranged in a matrix comprising columns and rows,
a distance between centers of a pair of pixels in adjacent columns is equal to a distance between centers of a pair of pixels in adjacent rows.
an axial direction of cylindrical lenses of the plurality of cylindrical lenses coincides with a diagonal direction of the pixels.

2. The display device of claim 1, an axial direction of cylindrical lenses of the plurality of cylindrical lenses coincides with a diagonal direction of the pixels.

3. The display device of claim 1, wherein the axial direction of the cylindrical lenses is a longitudinal axial direction of the cylindrical lenses.

4. The display device of claim 1, wherein the axial direction of the cylindrical lenses forms an angle in a range of approximately 40° to approximately 50° with respect to one of a column direction and a row direction of the matrix.

5. The display device of claim 4, wherein the axial direction of the cylindrical lenses forms an angle of approximately 45° with respect to one of a column direction and a row direction of the matrix.

6. The display device of claim 1, wherein a length of a longitudinal side of the pixels is in a range of approximately 0.9 times to approximately 1.1 times a length of a latitudinal side of the pixels.

7. The display device of claim 6, wherein the pixels are formed as squares.

8. The display device of claim 1, wherein the pixels are arranged symmetrically with respect to the axial direction of the cylindrical lenses.

9. The display device of claim 1, further comprising a plurality of viewpoints defined by the cylindrical lenses, wherein
viewpoints of the plurality of viewpoints are aligned perpendicular to the axial direction of the cylindrical lenses, and
a distance between a pair of adjacent viewpoints is approximately 1/\sqrt{2} times one of the distance between the centers of the pair pixels in adjacent columns and the distance between the centers of the pair of pixels in adjacent rows.

10. The display device of claim 1, further comprising a plurality of viewpoints defined by the cylindrical lenses, wherein
the viewpoints are aligned in a direction having an angle of approximately 45° with respect to the axial direction of the cylindrical lenses,
each of the cylindrical lenses overlaps a number of pixels, and
the number of pixels overlapped by each of the cylindrical lenses corresponds to the number of viewpoints.

11. The display device of claim 1, wherein the axial direction of the cylindrical lenses is parallel to one of a long peripheral side and a short peripheral side of the display panel.

12. A display device comprising:
a display panel on which a plurality of pixels is formed; and
a lenticular sheet disposed above the display panel and comprising a plurality of cylindrical lenses formed on the lenticular sheet, wherein
pixels of the plurality of pixels are arranged in a matrix comprising columns and rows,
an axial direction of cylindrical lenses of the plurality of cylindrical lenses forms an angle in a range of approximately 40° to approximately 50° with respect to one of a column direction and a row direction of the matrix, and
the pixels are arranged symmetrically with respect to the axial direction of the cylindrical lenses.

13. The display device of claim 12, wherein the axial direction of the cylindrical lenses forms an angle of approximately 45° with respect to the one of the column direction and the row direction of the matrix.

14. The display device of claim 12, wherein a length of a longitudinal side of the pixels is in a range of approximately 0.9 times to approximately 1.1 times a length of a latitudinal side of the pixels.

15. The display device of claim 14, wherein the pixels are formed as squares.

16. The display device of claim 12, wherein distances between pairs of adjacent pixels are uniform.

17. The display device of claim 12, wherein the pixels are arranged symmetrically with respect to the axial direction of the cylindrical lenses.

18. The display device of claim 12, further comprising a plurality of viewpoints defined by the cylindrical lenses, wherein
viewpoints of the plurality of viewpoints are aligned perpendicular to the axial direction of the cylindrical lenses, and
a distance between a pair of adjacent viewpoints is approximately 1/\sqrt{2} times a distance between centers of one of a pair of pixels in adjacent columns and a pair of pixels in adjacent rows.

19. The display device of claim 12, further comprising a plurality of viewpoints defined by the cylindrical lenses, wherein
the viewpoints are aligned in a direction having an angle of approximately 45° with respect to the axial direction of the cylindrical lenses,
each of the cylindrical lenses overlaps a number of pixels, and
the number of pixels overlapped by each of the cylindrical lenses corresponds to the number of viewpoints.

20. The display device of claim 12, wherein the axial direction of the cylindrical lenses is a longitudinal axial direction of the cylindrical lenses.
